(19) United States
(12) Patent Application Publication
(10) Pub. No.: US 2025/0216281 A1
(43) Pub. Date: Jul. 3, 2025

(54) DEVICE AND METHOD FOR CAVITATION DETECTION OF PURE WATER HYDRAULIC SYSTEM BASED ON PRESSURE

(71) Applicant: SHANDONG UNIVERSITY OF SCIENCE AND TECHNOLOGY, Qingdao (CN)

(72) Inventors: Qiang ZHANG, Qingdao (CN); Shouji SUN, Qingdao (CN); Ying TIAN, Qingdao (CN); Chunyong FAN, Qingdao (CN); Hengxuan LUAN, Qingdao (CN); Feng ZHOU, Qingdao (CN); Dongliang WEI, Qingdao (CN); Li YIN, Qingdao (CN); Hong ZHANG, Qingdao (CN); Bofeng CHANG, Qingdao (CN); Xin LIU, Qingdao (CN); Chenglong WANG, Qingdao (CN); Ya LIU, Qingdao (CN); Chao ZHANG, Qingdao (CN); Yunjie PENG, Qingdao (CN); Jinpeng SU, Qingdao (CN); Shaohua LI, Qingdao (CN)

(21) Appl. No.: 19/021,636

(22) Filed: Jan. 15, 2025

Related U.S. Application Data
(63) Continuation of application No. PCT/CN2024/078221, filed on Feb. 23, 2024.

(30) Foreign Application Priority Data
Dec. 28, 2023 (CN) 202311830419.5

(51) Int. Cl. G01L 23/12; F15B 19/00; F15B 21/047

(52) U.S. Cl. CPC G01L 23/125; F15B 19/00; F15B 21/047; F15B 2211/8609

(57) ABSTRACT

A device for cavitation detection of a pure water hydraulic system based on pressure includes a chamber component; an inner diameter of the drainage nozzle gradually increases along an inflow direction of a liquid medium, so as to reduce a flow velocity of the liquid medium after being drained into the drainage nozzle; and the detection assembly includes a housing, one end of the housing facing the drainage nozzle is an open end, an elastic cover sheet is arranged in the open end, an electrode is arranged in the housing, diaphragms are respectively arranged on two sides of the electrode, and the electrode is closely attached to the elastic cover sheet through one of the diaphragms; the liquid medium is ejected from the drainage nozzle and impacts the elastic cover sheet.

### CROSS-REFERENCE TO RELATED APPLICATIONS

This application is a continuation of PCT/CN2024/078221, filed Feb. 23, 2024 and claims priority of Chinese Patent Application No. 202311830419.5, filed on Dec. 28, 2023, the entire contents of which are incorporated herein by reference.

### TECHNICAL FIELD

The present disclosure relates to the technical field of pure water hydraulic systems, and in particular relates to a device and a method for cavitation detection of a pure water hydraulic system based on pressure.

### BACKGROUND

Hydraulic transmission is a transmission mode that uses liquid as working medium to transfer energy, exchange energy and control. Hydraulic transmission and pneumatic transmission are called fluid transmission. Fluid transmission is a new technology developed according to the principle of hydrostatic transmission put forward by Pascal in the 17th century, and is widely used in engineering machinery, construction machinery, agricultural machinery, metallurgical machinery, mining machinery, space launch and other fields. At present, the level of fluid transmission technology has become an important symbol of the level of industrial development.

Because pure water has many advantages, such as easy access to materials, low price, no pollution, no combustion and low compressibility, pure water may replace mineral oil in various fields, so pure water hydraulic transmission has attracted more and more attention.

However, the air separation pressure of pure water is higher than the air separation pressure of traditional mineral oil, and pure water contains more air than traditional mineral oil under the same conditions, thus leading to cavitation in pure water hydraulic system more easily than traditional hydraulic-oil hydraulic system.

Cavitation is the phenomenon of surface deformation and material erosion after the object is impacted by cavitation during liquid movement, also known as erosion or cavitation erosion. In the process of cavitation, cavitation bubbles are rapidly generated, and then expand and collapse, forming shock waves or high-speed micro-jets in the liquid. After being impacted, the surface crystal structure of the metal materials is distorted, resulting in chemical instability, which makes the adjacent grains have different potentials, thereby accelerating the electrochemical corrosion process. The mechanical properties of materials in erosion area deteriorated significantly, resulting in a sharp increase in the amount of cavitation erosion. In the design of pure water hydraulic system, it is necessary to conduct model tests in advance and take measures to avoid cavitation as much as possible. In order to avoid cavitation, it is necessary to first detect whether cavitation has occurred and the degree of its occurrence. Therefore, there is an urgent need for a device and a method for cavitation detection of a pure water hydraulic system based on pressure to solve the above problems.

### SUMMARY

An objective of the present disclosure is to provide a device and a method for cavitation detection of a pure water hydraulic system based on pressure, so as to solve the problems existing in the prior art.

In order to achieve the above objectives, the present disclosure provides a following solution: a device for cavitation detection of a pure water hydraulic system based on pressure, including:
a chamber component;
a drainage nozzle arranged in the chamber component, where the drainage nozzle is in communication with the pure water hydraulic system, and an inner diameter of the drainage nozzle gradually increases along an inflow direction of a liquid medium, so as to reduce a flow velocity of the liquid medium after being drained into the drainage nozzle; and
a detection assembly arranged in the chamber component, where the detection assembly includes a housing, one end of the housing facing the drainage nozzle is an open end, an elastic cover sheet is arranged in the open end, an electrode is arranged in the housing, diaphragms are respectively arranged on two sides of the electrode, and the electrode is closely attached to the elastic cover sheet through one of the diaphragms;
where the liquid medium is ejected from the drainage nozzle and impacts the elastic cover sheet, so as to enable the elastic cover sheet to vibrate and change a potential on the two sides of the electrode, and output electrical signals are input to a terminal.

In an embodiment, the chamber component includes:
a cylinder body; and
an upper cylinder head and a lower cylinder head respectively fixedly connected to two ends of the cylinder body through screws;
where the drainage nozzle is fixedly connected to the lower cylinder head, and the housing is fixedly connected to the upper cylinder head.

In an embodiment, the drainage nozzle and the housing are fixedly connected to the lower cylinder head and the upper cylinder head respectively through nuts.

In an embodiment, a thin tube is arranged on each of the lower cylinder head and the drainage nozzle;
where the thin tube in communication with the drainage nozzle is used for introducing the liquid medium into the drainage nozzle, and the thin tube in communication with the lower cylinder head is used for leading out the liquid medium in the chamber component.

In an embodiment, an inner wall of the housing is fixedly connected to a circular insulating sleeve, and the electrode is arranged in the circular insulating sleeve.

A method for cavitation detection of a pure water hydraulic system based on pressure is provided, and the method includes:
connecting the hydraulic system to the drainage nozzle, so as to introduce the liquid medium into the chamber component through the drainage nozzle;
slowing down the velocity of the liquid medium passing through the drainage nozzle and increasing pressure and accelerating rupture, so as to cause pressure fluctuations at a bottom of the detection assembly;
converting the pressure fluctuations into corresponding electrical signals by the detection assembly; and

inputting the electrical signals to the terminal and judging whether cavitation occurs.

In an embodiment, the electric signals are collected pressure values and are continuous electric signals, an average value of the pressure values in three seconds is n, then a highest pressure value in the three seconds is m, and the electric signals are input to the terminal and a judging method for judging whether the cavitation occurs is as follows:
when n is less than 10 megapascal (MPa) and m is more than 2 n, the cavitation occurs, otherwise the cavitation does not occur;
when n is greater than 10 MPa and less than 20 MPa, and m is greater than 1.5 n, the cavitation occurs, otherwise the cavitation does not occur;
when n is greater than 20 MPa and less than 30 MPa, and m is greater than 1.3 n, the cavitation occurs, otherwise the cavitation does not occur; and
when n is greater than 30 MPa and m is greater than 1.1 n, the cavitation occurs, otherwise the cavitation does not occur.

The present disclosure has the following technical effects. The drainage inclination of the drainage nozzle in the present disclosure may promote the rupture of cavitation bubbles, so that the detection assembly may detect the vibration caused by the rupture of cavitation bubbles more sensitively, and further realize the cavitation detection of the pure water hydraulic system.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without paying creative labor.

FIG. 1 is a schematic diagram of an overall structure of a device for cavitation detection of a pure water hydraulic system based on pressure according to the present disclosure.

FIG. 2 is a schematic diagram of an internal structure according to the present disclosure.

FIG. 3 is a schematic structural diagram of a detection assembly in the present disclosure.

FIG. 4 is a three-dimensional diagram of the device for cavitation detection of a pure water hydraulic system based on pressure according to the present disclosure.

FIG. 5 is a flowchart of a method for cavitation detection of a pure water hydraulic system based on pressure according to the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more clearly understandable, the present disclosure will be further described in detail with the attached drawings and specific embodiments.

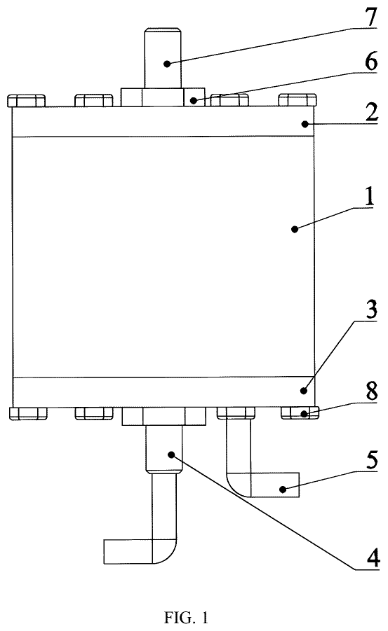

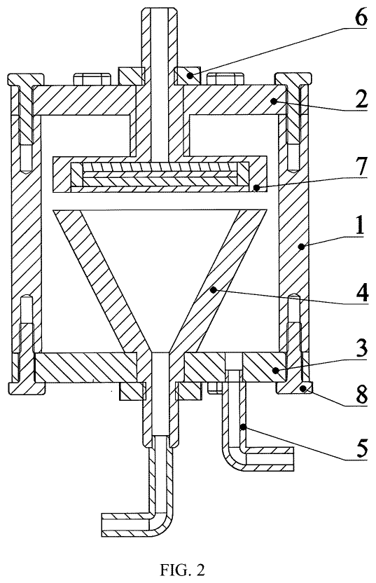

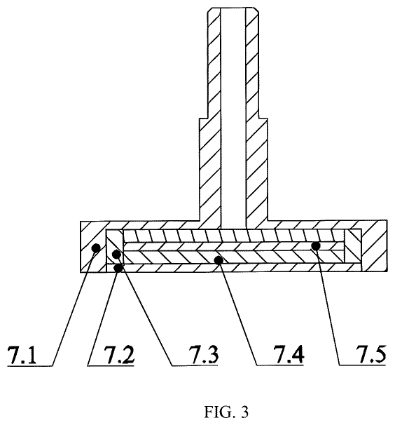

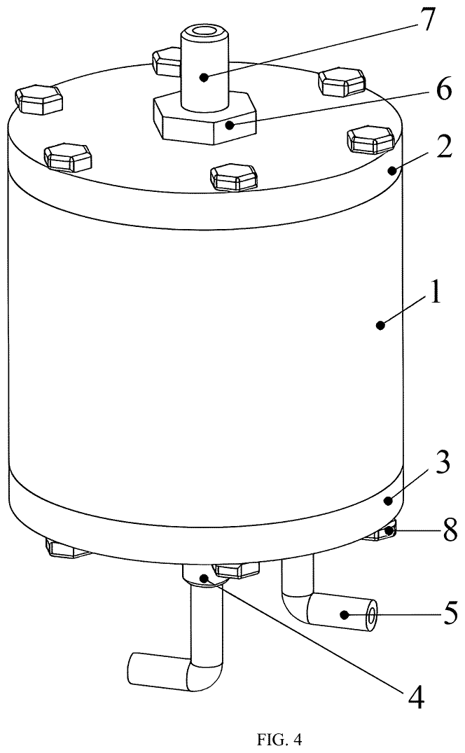

With reference to FIG. 1 to FIG. 4, the present disclosure provides a device for cavitation detection of a pure water hydraulic system based on pressure, and the device includes a chamber component, a drainage nozzle 4 and a detection assembly.

The drainage nozzle 4 is arranged in the chamber component and is in communication with the pure water hydraulic system, and the inner diameter of the drainage nozzle 4 gradually increases along the inflow direction of the liquid medium, causing a flow velocity of the liquid medium to decrease after being drained into the drainage nozzle 4.

The detection assembly 7 is arranged in the chamber component, and the detection assembly 7 includes a housing 7.1, one end of the housing 7.1 facing the drainage nozzle 4 is an open end, an elastic cover sheet 7.2 is arranged in the open end, an electrode 7.5 is arranged in the housing 7.1, diaphragms 7.4 are respectively arranged on two sides of the electrode 7.5, and the electrode 7.5 is closely attached to the elastic cover sheet 7.2 through one of the diaphragms 7.4.

The liquid medium is ejected from the drainage nozzle 4 and impacts the elastic cover sheet 7.2, causing the elastic cover sheet 7.2 to vibrate and causing a change in the potential on two sides of the electrode 7.5, and inputting the output electrical signal to the terminal.

The drainage inclination of the drainage nozzle 4 arranged in the present disclosure may promote the cavitation bubble rupture, so that the detection assembly 7 may detect the vibration caused by the cavitation bubble rupture more sensitively, and further realize the cavitation detection of the pure water hydraulic system.

In an embodiment, the chamber component includes a cylinder body 1, an upper cylinder head 2 and a lower cylinder head 3. The upper cylinder head 2 and the lower cylinder head 3 are respectively fixedly connected to two ends of the cylinder body 1 through screws 8.

The drainage nozzle 4 is fixedly connected to the lower cylinder head 3, and the housing 7.1 is fixedly connected to the upper cylinder head 2.

The main structure of the cylinder body 1 is a cylindrical cylinder body 1, six threaded holes are uniformly distributed in each of the upper part and lower part for fixing the upper cylinder head 2 and the lower cylinder head 3 through screws 8. The center of the upper cylinder head 2 is opened with a cylindrical hole for installation of with the detection assembly 7, and the upper part of the detection assembly 7 provided with cylindrical threads and is tightly connected to the upper cylinder head 2 by connecting the nut 6. The center of the lower cylinder head 3 is opened with a cylindrical hole to connect to the drainage nozzle 4, and the lower part of the drainage nozzle 4 is provided with cylindrical threads and tightly connected to the lower cylinder head 3 by connecting the nut 6. A small circular hole is opened beside the center of the lower cylinder head 3 and is connected to the thin tube 5, and the circular hole at the lower opening of the drainage nozzle 4 is also used to connect to the thin tube 5.

In an embodiment, the drainage nozzle 4 and the housing 7.1 are fixedly connected to the lower cylinder head 3 and the upper cylinder head 2 respectively via nuts 6.

In an embodiment, the lower cylinder head 3 and the drainage nozzle 4 are each provided with a thin tube 5.

The thin tube 5 in communication with the drainage nozzle 4 is used for introducing the liquid medium into the drainage nozzle 4, and the thin tube 5 in communication with the lower cylinder head 3 is used for leading out the liquid medium in the chamber component.

In an embodiment, the inner wall of the housing 7.1 is fixedly connected to a circular insulating sleeve 7.3, and the electrode 7.5 is arranged in the circular insulating sleeve 7.3.

Before using the detection device, firstly, the detection device is connected to the pure water hydraulic system through the thin tube 5 to introduce the liquid medium. The liquid medium flows into the drainage nozzle 4 through the thin tube 5, and enters the cylinder body 1. The inclination of the drainage nozzle 4 promotes the cavitation bubble rupture, thereby causing the vibration of the elastic cover sheet 7.2 at the lower part of the detection assembly 7, driving the diaphragms 7.4 in the detection assembly 7 to vibrate, causing the potential on two sides of the electrode 7.5 to change, and detecting the electrical signal transmitted from the upper part of the housing 7.1. The liquid medium flows to the elastic cover sheet 7.2, then flows downwards through the inner wall of the cylinder body 1 and flows out from the thin tube 5 connected to the circular hole beside the center of the lower cylinder head 3.

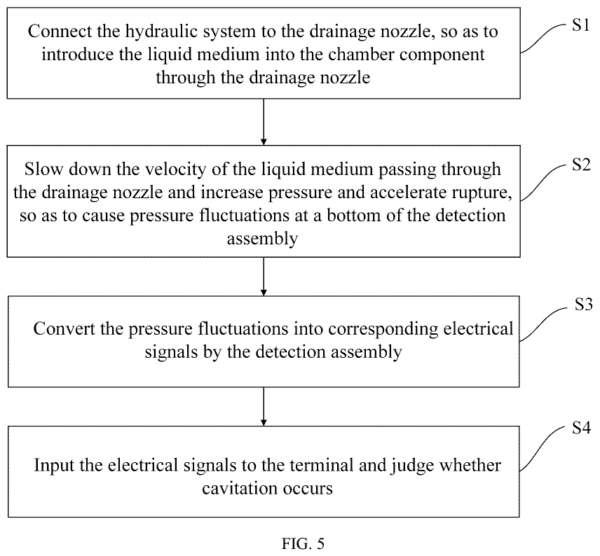

As shown in FIG. 5, a method for cavitation detection of a pure water hydraulic system based on pressure is provided, the method includes the following steps.

S1, the hydraulic system is connected to the drainage nozzle 4, so that the liquid medium is introduced into the chamber component through the drainage nozzle 4.

S2, the velocity of the liquid medium passing through the drainage nozzle 4 slows down, and the pressure increases to accelerate the rupture, causing pressure fluctuations at the bottom of the detection assembly 7.

S3, the pressure fluctuations are converted into the corresponding electrical signals by the detection assembly 7.

S4, the electrical signals are input to the terminal and whether cavitation occurs is judged.

In an embodiment, the electric signals are the collected pressure values and are continuous electric signals, the average value of the pressure values in three seconds is n, and the highest pressure value in three seconds is m. The electric signals are input to the terminal and the judging method for judging whether cavitation occurs is as follows.

When n is less than 10 MPa and m is more than 2 n, cavitation occurs, otherwise cavitation does not occur.

When n is greater than 10 MPa and less than 20 MPa, and m is greater than 1.5 n, cavitation occurs, otherwise cavitation does not occur.

When n is greater than 20 MPa and less than 30 MPa, and m is greater than 1.3 n, cavitation occurs, otherwise cavitation does not occur.

When n is greater than 30 MPa and m is greater than 1.1 n, cavitation occurs, otherwise cavitation does not occur.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

what is claimed is:

1. A device for cavitation detection of a pure water hydraulic system based on pressure, comprising:
a chamber component;
a drainage nozzle arranged in the chamber component, wherein the drainage nozzle is in communication with the pure water hydraulic system, and an inner diameter of the drainage nozzle gradually increases along an inflow direction of a liquid medium, so as to reduce a flow velocity of the liquid medium after being drained into the drainage nozzle; and
a detection assembly arranged in the chamber component, wherein the detection assembly comprises a housing, one end of the housing facing the drainage nozzle is an open end, an elastic cover sheet is arranged in the open end, an electrode is arranged in the housing, diaphragms are respectively arranged on two sides of the electrode, and the electrode is closely attached to the elastic cover sheet through one of the diaphragms;
wherein the liquid medium is ejected from the drainage nozzle and impacts the elastic cover sheet, so as to enable the elastic cover sheet to vibrate and change a potential on the two sides of the electrode, and output electrical signals are input to a terminal.

2. The device for cavitation detection of a pure water hydraulic system based on pressure according to claim 1, wherein the chamber component comprises:
a cylinder body; and
an upper cylinder head and a lower cylinder head respectively fixedly connected to two ends of the cylinder body through screws;
wherein the drainage nozzle is fixedly connected to the lower cylinder head, and the housing is fixedly connected to the upper cylinder head.

3. The device for cavitation detection of a pure water hydraulic system based on pressure according to claim 2, wherein the drainage nozzle and the housing are fixedly connected to the lower cylinder head and the upper cylinder head respectively through nuts.

4. The device for cavitation detection of a pure water hydraulic system based on pressure according to claim 3, wherein a thin tube is arranged on each of the lower cylinder head and the drainage nozzle;
wherein the thin tube in communication with the drainage nozzle is used for introducing the liquid medium into the drainage nozzle, and the thin tube in communication with the lower cylinder head is used for leading out the liquid medium in the chamber component.

5. The device for cavitation detection of a pure water hydraulic system based on pressure according to claim 4, wherein an inner wall of the housing is fixedly connected to a circular insulating sleeve, and the electrode is arranged in the circular insulating sleeve.

6. A method for cavitation detection of a pure water hydraulic system based on pressure, based on the device for cavitation detection of a pure water hydraulic system based on pressure according to claim 1, comprising following steps:
connecting the hydraulic system to the drainage nozzle, so as to introduce the liquid medium into the chamber component through the drainage nozzle;
slowing down the velocity of the liquid medium passing through the drainage nozzle and increasing pressure and accelerating rupture, so as to cause pressure fluctuations at a bottom of the detection assembly;
converting the pressure fluctuations into corresponding electrical signals by the detection assembly; and
inputting the electrical signals to the terminal and judging whether cavitation occurs.

7. The method for cavitation detection of a pure water hydraulic system based on pressure according to claim 6, wherein the electric signals are collected pressure values and are continuous electric signals, an average value of the pressure values in three seconds is n, then a highest pressure value in the three seconds is m, and the electric signals are input to the terminal and a judging method for judging whether the cavitation occurs is as follows:
when n is less than 10 MPa and m is more than 2 n, the cavitation occurs, otherwise the cavitation does not occur;
when n is greater than 10 MPa and less than 20 MPa, and m is greater than 1.5 n, the cavitation occurs, otherwise the cavitation does not occur;
when n is greater than 20 MPa and less than 30 MPa, and m is greater than 1.3 n, the cavitation occurs, otherwise the cavitation does not occur; and
when n is greater than 30 MPa and m is greater than 1.1 n, the cavitation occurs, otherwise the cavitation does not occur.
